(19) United States
(12) Patent Application Publication
(10) Pub. No.: US 2026/0270551 A1
(43) Pub. Date: Sep. 10, 2026

(54) RECORDING SYSTEM, RECORDING METHOD, AND RECORDING PROGRAM

(71) Applicant: NEC Corporation, Tokyo (JP)

(72) Inventors: Eiichi TOKUMI, Tokyo (JP); Kenichi KIJIMA, Tokyo (JP); Tetsuya TANABIKI, Tokyo (JP); Takahiro MIZUTA, Tokyo (JP); Taichi SEISHI, Tokyo (JP); Takuya NOMURA, Tokyo (JP); Takumi KAMIYAMA, Tokyo (JP)

(73) Assignee: NEC Corporation, Tokyo (JP)

(21) Appl. No.: 19/163,990

(22) PCT Filed: Dec. 13, 2023
(86) PCT No.: PCT/JP2023/044596

§ 371 Date: Sep. 10, 2025

(30) Foreign Application Priority Data
Mar. 24, 2023 (JP) 2023-049090

(51) Int. Cl. H04N 23/60; G06T 7/73; H04N 23/61

(52) U.S. Cl. CPC H04N 23/64; G06T 7/73; H04N 23/61; G06T 2207/30244

(57) ABSTRACT

The present disclosure has an object of providing a recording system, a recording method, and a recording program capable of more certainly confirming an imaging target. The image data acquisition unit acquires first image data captured by a camera provided in a moving body. The condition setting unit sets a recognition condition for recognizing the imaging target on the basis of at least one of the position of the target space and the date and the time of the capturing of the first image data. The target identification unit identifies an imaging target from the first image data. The position and posture determination unit determines the position and posture of the moving body with respect to the imaging target on the basis of the recognition condition in order to capture second image data including the imaging target. The recording control unit causes the second image data to be recorded.

### TECHNICAL FIELD

The present disclosure relates to a recording system, a recording method, and a recording program.

### BACKGROUND ART

The use of moving bodies such as drones that move in the air is increasing. In addition, along with this, diversification of scenes in which drones are used is expected. For example, use of drones for inspecting infrastructure facilities such as power transmission towers has been proposed.

PTL 1 describes an information processing device that appropriately controls exposure of a camera using photographed images of a plurality of cameras. In the information processing device disclosed in PTL 1, the position of a first camera in the future is predicted, and the brightness of a photographed image of the first camera at the predicted position is predicted from a photographed image of the second camera at the present or in the past. As a result, in the information processing device disclosed in PTL 1, the photographed image of the first camera at the predicted position is controlled to have appropriate brightness.

### CITATION LIST

### Patent Literature

PTL 1: WO 2022/065039 A1

### SUMMARY OF INVENTION

### Technical Problem

In the information processing device disclosed in PTL 1, it is necessary for the user to operate the moving body to perform photographing with the first camera and photographing with the second camera. In a case where the user is not familiar with the operation of the moving body, there is a possibility that the photographing target cannot be photographed and the photographing target cannot be sufficiently confirmed.

In view of the above-described problems, an object of the present disclosure is to provide a recording system, a recording method, and a recording program capable of more reliably confirming a photographing target.

### Solution to Problem

A recording system according to one aspect of the present disclosure includes
an image data acquisition unit for acquiring first image data photographed by a camera provided in a moving body that has moved to a target space based on position data registered in advance,
a condition setting unit for setting a recognition condition for recognizing a photographing target based on at least one of a position of the target space and a date and time at which the first image data is photographed,
a target specifying unit for specifying the photographing target from the first image data,
a position/posture determination unit for determining a position/posture of the moving body with respect to the photographing target based on the recognition condition to photograph second image data including the photographing target, and
a recording control unit for recording the second image data.

A recording method according to one aspect of the present disclosure, is executed by a computer and includes
acquiring first image data photographed by a camera provided in a moving body that has moved to a target space based on position data registered in advance,
setting a recognition condition for recognizing a photographing target based on at least one of a position of the target space and a date and time at which the first image data is photographed,
specifying the photographing target from the first image data, and determining a position/posture of the moving body with respect to the photographing target for photographing a second image including the photographing target according to the recognition condition, and
recording the second image data in which the photographing target is photographed.

A recording program according to one aspect of the present disclosure for causing a computer to execute processing of
acquiring first image data photographed by a camera provided in a moving body that has moved to a target space based on position data registered in advance,
setting a recognition condition for recognizing a photographing target based on at least one of a position of the target space and a date and time at which the first image data is photographed,
specifying the photographing target from the first image data, and determining a position/posture of the moving body with respect to the photographing target for photographing a second image including the photographing target according to the recognition condition, and
recording the second image data in which the photographing target is photographed.

### Advantageous Effects of Invention

According to the present disclosure, a recording system, a recording method, and a recording program capable of more reliably confirming a photographing target can be provided.

### BRIEF DESCRIPTION OF DRAWINGS

FIG. 1 is a block diagram illustrating a configuration of a recording system according to the present disclosure.

FIG. 2 is a flowchart illustrating a recording method according to the present disclosure.

FIG. 3 is a block diagram illustrating a usage example of the recording system according to the present disclosure.

FIG. 4 is a schematic diagram illustrating a usage example of the recording system according to the present disclosure.

FIG. 5 is a schematic diagram illustrating first image data and second image data in the recording system according to the present disclosure.

FIG. 6 is a schematic diagram illustrating a usage example of the recording system according to the present disclosure.

FIG. 7 is a schematic diagram illustrating a usage example of the recording system according to the present disclosure.

FIG. 8 is a diagram illustrating a learning example of a position/posture determination unit in the recording system according to the present disclosure.

FIG. 9 is a block diagram illustrating a usage example of the recording system according to the present disclosure.

FIG. 10 is a block diagram of the recording system according to the present disclosure.

FIG. 11 is a schematic diagram illustrating a usage example of the recording system according to the present disclosure.

FIG. 12 is a block diagram of the recording system according to the present disclosure.

FIG. 13 is a flowchart illustrating the recording method according to the present disclosure.

FIG. 14 is a flowchart illustrating the recording method according to the present disclosure.

FIG. 15 is a flowchart illustrating the recording method according to the present disclosure.

FIG. 16 is a block diagram illustrating a configuration example of a management device 201 and the like according to the present disclosure.

### EXAMPLE EMBODIMENT

Hereinafter, the present disclosure will be described according to example embodiments, but the disclosure described in the claims is not limited to the following example embodiments. Not all the configurations described in the example embodiments are essential as means for solving the problem. For clarity of description, the following description and drawings are omitted and simplified as appropriate. In the drawings, the same elements are denoted by the same reference numerals, and repeated description is omitted as necessary.

### First Example Embodiment

### <Recording System>

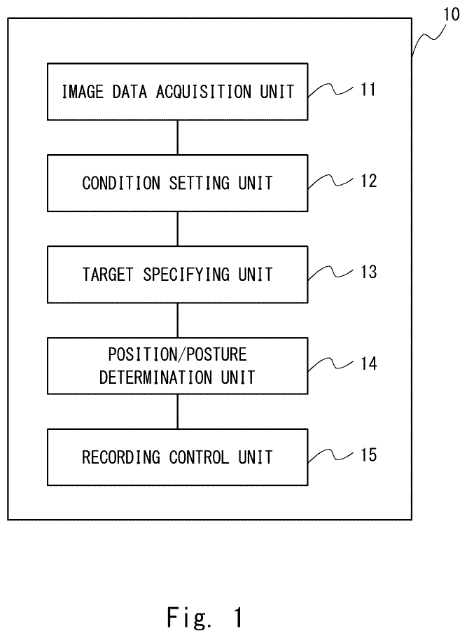

Hereinafter, a recording system according to the present disclosure will be described with reference to the drawings. FIG. 1 is a block diagram illustrating a configuration of a recording system according to the present disclosure. A recording system 10 according to the present disclosure includes an image data acquisition unit 11, a condition setting unit 12, a target specifying unit 13, a position/posture determination unit 14, and a recording control unit 15.

The image data acquisition unit 11 acquires first image data photographed by a camera provided in a moving body that has moved to a target space based on position data registered in advance. The target space is a space including a photographing target. For example, in the inspection of the power transmission tower, a plurality of inspection points of the power transmission tower are inspected collectively, but the photographing target is each inspection point of the power transmission tower, and the target space is a surrounding space including each inspection point of the power transmission tower. The target space may be one space corresponding to a plurality of photographing targets or a plurality of spaces corresponding to each photographing target on a one-to-one basis.

For example, in a case where there are three photographing targets, the target space may be one space including the three photographing targets, or may be two spaces in which one space includes two photographing targets and the other space includes the remaining one photographing target. Since the first image data is photographed by a camera provided in the moving body that has moved to the target space, the first image data includes a photographing target.

The moving body is a moving body that moves in the air, and is, for example, a drone (autonomous flying object) or a flying car. The moving body estimates its own position using, for example, Simultaneous Localization and Mapping (SLAM). In the SLAM, the machine body position is calculated based on an environment map that is point cloud data of the surrounding environment obtained by a distance measuring sensor such as LIDAR. The moving body estimates its own position and moves toward the target space based on the received position data registered in advance.

The condition setting unit 12 sets a recognition condition for recognizing the photographing target based on at least one of the position of the target space and the date and time at which the first image data is photographed. The recognition conditions are geographic conditions, seasonal conditions, weather conditions such as weather, temperature, and wind speed, and date and time conditions. The geographical condition includes terrain information associated with a position indicated using latitude, longitude, or the like, and information of a surrounding environment indicating nature or an artificial structure. In addition, the recognition condition includes color, brightness, and contrast due to weather based on each condition of geographical conditions, seasonal conditions, weather conditions such as weather, temperature, and wind speed, and date and time conditions.

The target specifying unit 13 specifies a photographing target from the first image data. For example, since the inspection point is determined in the periodic inspection of the infrastructure maintenance, the type of the infrastructure facility is determined from the first image data, and the inspection point that is the photographing target is specified.

In order to photograph the second image data including the photographing target, the position/posture determination unit 14 determines the position/posture of the moving body with respect to the photographing target based on the recognition condition. The position/posture of the moving body with respect to the photographing target is, for example, in which direction the moving body is located with respect to the photographing target and at what altitude the moving body is flying. The position/posture of the moving body with respect to the photographing target is, for example, flying in the east direction with respect to the photographing target while maintaining an altitude of 100 meters. In addition, the position/posture of the moving body with respect to the photographing target may be for example, flying while being inclined several degrees with respect to the horizontal line, including the degree of inclination of the airframe. Furthermore, the position/posture determination unit 14 may determine not only the direction and the altitude of the moving body with respect to the photographing target but also the distance from the photographing target.

Upon determining the position/posture of the moving body, the position/posture determination unit 14 transmits a signal indicating to control the position/posture of the moving body to the moving body. Upon receiving the signal, the moving body moves based on the determined position/posture, and photographs the second image data including the photographing target. For example, the moving body may photograph the second image by approaching the photographing target, or may photograph the second image by zooming the camera provided in the moving body.

Here, the first image data is photographed by a camera provided in the moving body that has moved to the target space, and includes a photographing target. However, the first image data is an image for specifying the photographing target, and for example, the user cannot confirm the photographing target using the first image data due to reasons such as the photographing target in the first image data being small.

On the other hand, similarly to the first image data, the second image data is photographed by a camera provided in the moving body, and includes a photographing target. In addition, the second image data is an image photographed in consideration of the recognition condition, and for example, since the photographing target in the second image data is large and clear, the user can confirm the photographing target using the second image data. In this manner, the second image data is a confirmation image for the user to confirm the photographing target.

The recording control unit 15 records the second image data including the photographing target. The recording destination by the recording control unit 15 is, for example, a memory such as a Random Access Memory (RAM) or a Read Only Memory (ROM).

### <Recording Method>

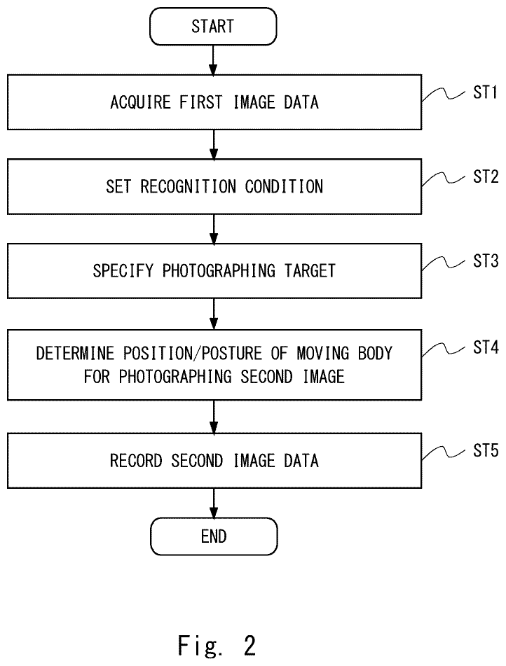

Next, a recording method according to the present disclosure will be described. FIG. 2 is a flowchart illustrating a recording method according to the present disclosure.

First, the image data acquisition unit 11 acquires first image data photographed by a camera provided in a moving body that has moved to a target space based on position data registered in advance (step ST1).

Next, the condition setting unit 12 sets a recognition condition for recognizing the photographing target based on at least one of the position of the target space and the date and time at which the first image data is photographed (step ST2).

Next, the target specifying unit 13 specifies the photographing target from the first image data (step ST3), and the position/posture determination unit 14 determines the position/posture of the moving body with respect to the photographing target based on the recognition condition in order to photograph the second image data including the photographing target (step ST4).

Then, the recording control unit 15 records the second image data including the photographing target in, for example, a memory such as a RAM or a ROM (step ST5).

As described above, in the recording system 10 according to the present disclosure, the position/posture of the moving body with respect to the photographing target are determined based on the recognition condition for recognizing the photographing target, and the second image data photographed by the moving body based on the determined position/posture is recorded. With such a configuration, even if the user is not familiar with the operation of the moving body, the photographing target can be easily photographed, and the photographing target can be more reliably confirmed using the second image data.

Here, the inspection of the power transmission tower is adopted by way of an example as an example of confirming the photographing target using the recording system 10, but this is not the sole case, and the recording system 10 according to the present disclosure can also be used in infrastructure maintenance such as inspection of a substation, and disasters such as fire and tsunami.

### Second Example Embodiment

### <Recording System>

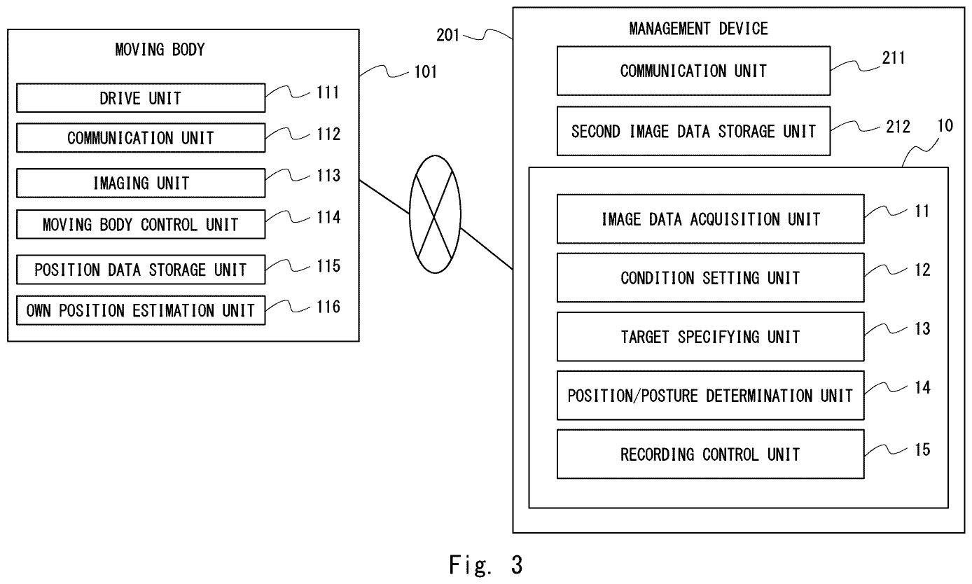

Hereinafter, a recording system according to the present disclosure will be described with reference to the drawings. FIG. 3 is a block diagram illustrating a usage example of the recording system according to the present disclosure. FIG. 3 illustrates a moving body 101 and a management device 201. The moving body 101 and the management device 201 are connected to be able to perform wireless communication.

The moving body 101 includes a drive unit 111, a communication unit 112, an imaging unit 113, a moving body control unit 114, a position data storage unit 115, and an own position estimation unit 116. The management device 201 includes a communication unit 211, a second image data storage unit 212, an image data acquisition unit 11, a condition setting unit 12, a target specifying unit 13, a position/posture determination unit 14, and a recording control unit 15. As illustrated in FIG. 3, the management device 201 includes a recording system 10 according to the present disclosure illustrated in FIG. 1.

First, a configuration of the moving body 101 will be described. The drive unit 111 includes a motor for rotating a propeller that is a moving means of the moving body 101. The imaging unit 113 is, for example, a camera for photographing the first image data and the second image data. The moving body control unit 114 includes an arithmetic device such as a CPU or an MCU and controls each configuration of the moving body 101. That is, the moving body control unit 114 exchanges information with the management device 201 via the communication unit 112, and issues an instruction to each configuration of the moving body 101 accordingly. The position data storage unit 115 includes a non-volatile memory such as a flash memory or an SSD, and stores position data of the target space. The own position estimation unit 116 estimates the own position using SLAM or the like.

Next, a configuration of the management device 201 will be described. Since the image data acquisition unit 11, the condition setting unit 12, the target specifying unit 13, the position/posture determination unit 14, and the recording control unit 15 are similar to those in FIG. 1, the description thereof will be omitted. The management device 201 exchanges information with the moving body 101 via the communication unit 211. The second image data storage unit 212 includes a non-volatile memory such as a flash memory or an SSD, and stores the second image data obtained by the imaging unit 113 of the moving body 101.

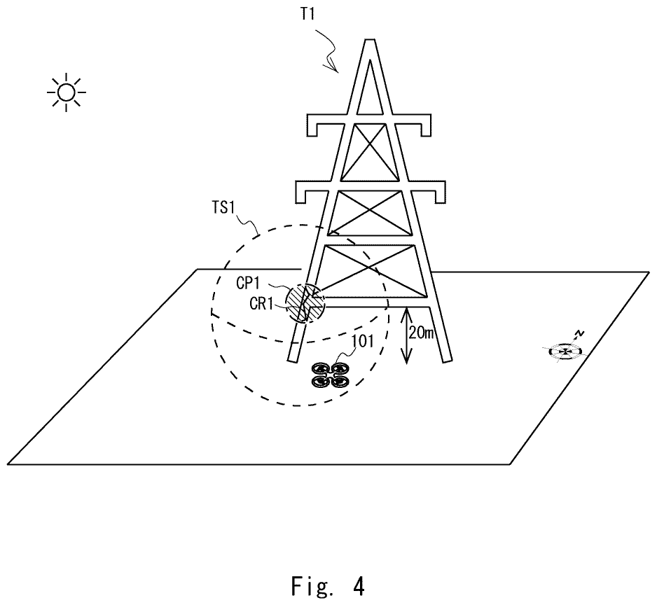

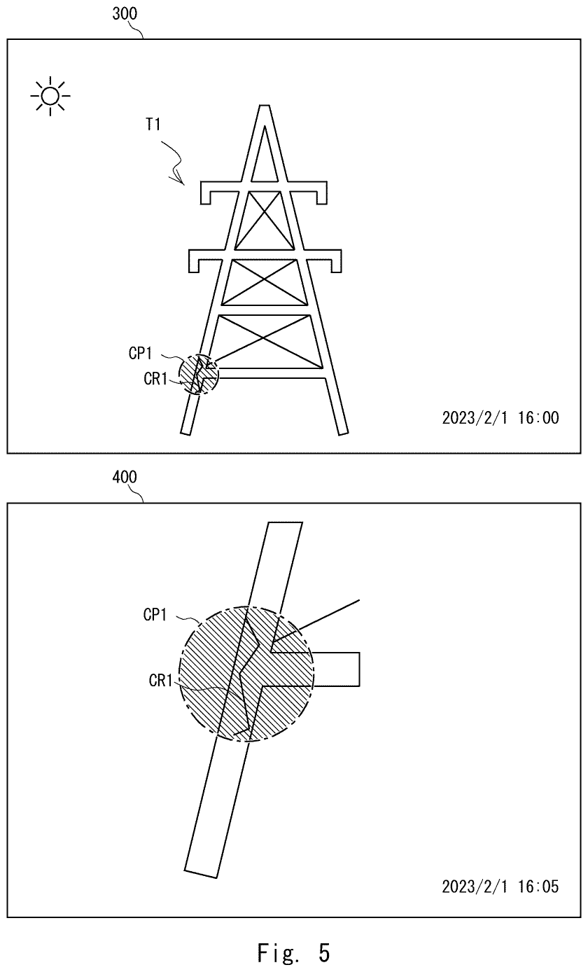

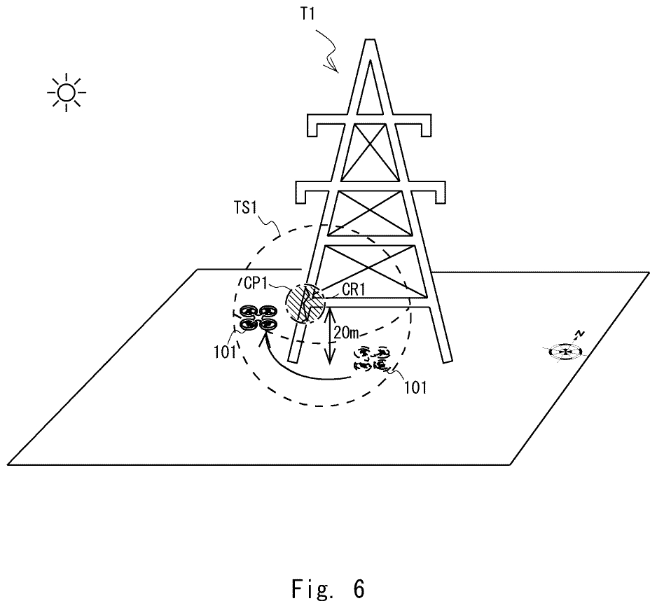

Here, a recording system according to the present disclosure will be described in more detail with reference to FIGS. 4 to 6. FIGS. 4 and 6 are schematic diagrams illustrating a usage example of the recording system according to the present disclosure. FIG. 5 is a schematic diagram illustrating first image data and second image data in the recording system according to the present disclosure. In the examples illustrated in FIGS. 4 to 6, the inspection of the power transmission tower T1 is taken as an example.

As illustrated in FIG. 4, it is assumed that the inspection point of the power transmission tower T1 is one inspection point CP1 with a flaw CRI. The photographing target in FIGS. 4 to 6 is the inspection point CP1. Furthermore, in FIGS. 4 to 6, it is assumed that the left direction of the drawing is the west side and the depth direction of the drawing is the north side. In the example illustrated in FIGS. 4 and 6, the target space is TS1.

First, since the position data storage unit 115 stores the position data of the target space TS1, the moving body 101 can move toward the target space TS1 as illustrated in FIG. 4. Then, the moving body 101 photographs the first image data 300 illustrated in FIG. 5 by the imaging unit 113. The first image data 300 illustrated in FIG. 5 includes the entire power transmission tower T1. In the first image data 300, it cannot be confirmed that there is a flaw CRI in the inspection point CP1.

Next, the management device 201 acquires the first image data 300 photographed by the moving body 101 by the image data acquisition unit 11. The condition setting unit 12 sets a recognition condition based on the position of the target space TS1 and the date and time at which the first image data is photographed. For example, in a case where the power transmission tower T1 is located at 45 degrees north latitude and 140 degrees east longitude, and the photographing date and time of the first image data 300 is the late afternoon in February as illustrated in FIG. 5, the condition setting unit 12 sets a recognition condition that it is a winter dusk time at a position of 45 degrees north latitude and 140 degrees east longitude.

Next, the target specifying unit 13 specifies the inspection point CP1 from the first image data 300. Then, the position/posture determination unit 14 determines the position/posture of the moving body with respect to the photographing target in order to photograph the second image data based on the recognition condition.

The position/posture of the moving body 101 will be described with reference to FIG. 6. The position/posture determination unit 14 determines that the sun is located on the west side from a recognition condition that it is a time zone of dusk at a position of 45 degrees north latitude and 140 degrees east longitude. In this case, if an attempt is made to photograph the second image data from the east side (right side in the drawing) toward the west side (left side in the drawing) of the inspection point CP1, the light becomes a back light, and a clear image of the inspection point CP1 cannot be acquired. On the other hand, if the second image data is photographed from the west side (left side in the drawing) toward the east side (right side in the drawing) of the inspection point CP1, the light does not become a back light, and a clear image of the inspection point CP1 can be acquired.

Therefore, the position/posture determination unit 14 determines to fly while maintaining an altitude of 20 m on the west side with respect to the inspection point CP1 in such a way that the moving body 101 can photograph from the west side with respect to the inspection point CP1.

Next, as illustrated in FIG. 6, once the moving body 101 flies in such a way as to maintain an altitude of 20 m on the west side with respect to the inspection point CP1, the second image data 400 illustrated in FIG. 5 is photographed by the imaging unit 113. Next, the management device 201 causes the recording control unit 15 to store the second image data 400 photographed by the imaging unit 113 in the second image data storage unit 212.

As illustrated in FIG. 5, in the second image data 400, the inspection point CP1 is enlarged as compared with the first image data 300. As a result, the user cannot confirm that the inspection point CP1 has the flaw CRI in the first image data 300, but can confirm that the inspection point CP1 has the flaw CRI in the second image data 400.

### <Movement Plan Path>

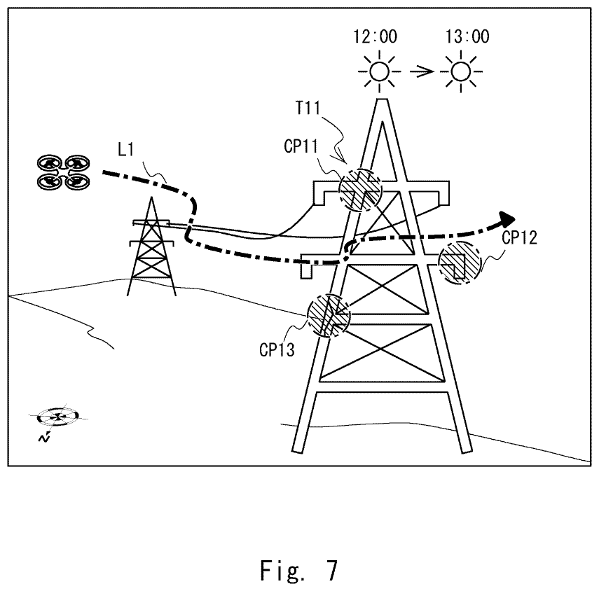

In the example illustrated in FIG. 5, the first image data 300 includes only one inspection point CP1, but is not limited thereto, and the first image data may include a plurality of photographing targets. In this case, the target specifying unit 13 creates the movement plan path of the photographing target from the first image data based on the recognition condition. A more specific description will be given with reference to FIG. 7. FIG. 7 is a schematic diagram illustrating a usage example of the recording system according to the present disclosure.

In the example illustrated in FIG. 7, the inspection points of the power transmission tower T11 are three points of the inspection points CP1 to CP3. The photographing targets in FIG. 7 are three points of the inspection points CP1 to CP3. In addition, in FIG. 7, it is assumed that the right direction of the drawing is the west side and the front direction of the drawing is the north side. In the example illustrated in FIG. 7, the target space is not illustrated, but it is assumed to be one space including three inspection points CP1 to CP3.

Furthermore, in the example illustrated in FIG. 7, it is assumed that the power transmission tower T11 is located at 25 degrees north latitude and 130 degrees east longitude, and the photographing date and time of the first image data is noon in summer. That is, the condition setting unit 12 sets a recognition condition that it is a midday time zone in summer at 25 degrees north latitude and 130 degrees east longitude.

The target specifying unit 13 determines that the sun is located directly above the power transmission tower T11 at 12:00 as illustrated in FIG. 7 from a recognition condition that it is a midday time zone in summer at 25 degrees north latitude and 130 degrees east longitude. Furthermore, as illustrated in FIG. 7, at 13:00, the target specifying unit 13 determines that the sun is located slightly on the west side (right side in FIG. 7) of the power transmission tower T11.

In this case, the inspection point CP11 and the inspection point CP13 are brightly illuminated by the sun at 12:00, whereas the position of the sun is shifted to the west at 13:00, so that the inspection point CP11 and the inspection point CP13 become slightly dark. On the other hand, the inspection point CP12 is more brightly illuminated by the sun at 13:00 than at 12:00.

Therefore, the target specifying unit 13 creates the movement plan path L1 in such a way that the inspection point CP11 and the inspection point CP13 are photographed first and the inspection point CP12 is photographed later. As a result, even if the user is not familiar with the operation of the moving body, it is possible to prevent the photographing of the second image data from failing and to efficiently acquire the second image data.

Here, as illustrated in FIG. 7, an example is illustrated in which the target specifying unit 13 creates the movement plan path based on the brightness according to the season condition. However, this is not the sole case, and the target specifying unit 13 may create the movement plan based on at least one of recognition conditions such as geographical conditions, seasonal conditions, weather conditions such as weather, temperature, and wind speed, and date and time conditions, and flight time.

Furthermore, the target specifying unit 13 may have the following configuration. First, the target specifying unit 13 calculates the photographing success rate of the second image data in each photographing target based on at least one of the recognition condition and the flight time.

The photographing success rate calculated by the target specifying unit 13 will be described by taking, as an example, a case where the moving body photographs two photographing targets separated from each other in a weather situation where it will rain 30 minutes later than the weather forecast. Here, it is assumed that the flight time with respect to one photographing target located near the moving body is within 30 minutes, and the flight time with respect to the other photographing target located far from the moving body exceeds 30 minutes.

Since the flight time of the moving body with respect to one of the photographing targets located near the moving body is within 30 minutes, there is a high possibility that it will not rain yet, and thus there is a high possibility that the photographing of the second image data will be successful. However, since the moving time of the moving body with respect to the other photographing target located far from the moving body exceeds 30 minutes, there is a possibility that the weather will change during the movement and it will be raining by the time the moving body arrives at the other photographing target. Therefore, the other photographing target located farther from the moving body has a lower possibility of succeeding in the photographing of the second image data than the other photographing target located closer to the moving body. In this manner, the target specifying unit 13 calculates the photographing success rate of the second image data with respect to each photographing target.

The calculation of the imaging success rate by the target specifying unit 13 may be calculated by the user selecting a condition regarding at least one of the recognition condition and the flight time. Furthermore, the user may select whether to calculate or not calculate the imaging success rate of the target specifying unit 13. As a matter of course, the target specifying unit 13 may calculate the photographing success rate of the second image data using a numerical value such as, for example, 50% or 0.5.

Then, the target specifying unit 13 creates a movement plan path indicating the order of flying each photographing target based on the photographing success rate. In the above-described example, one photographing target located close to the moving body is photographed in descending order of the possibility of succeeding in the photographing of the second image data, and the movement plan path for photographing the other photographing target located far from the moving body is created. As a result, even if the user is not familiar with the operation of the moving body, it is possible to further suppress failure of photographing the second image data and to efficiently acquire the second image data.

<Position/posture Determination of Moving Body using Learning Model>

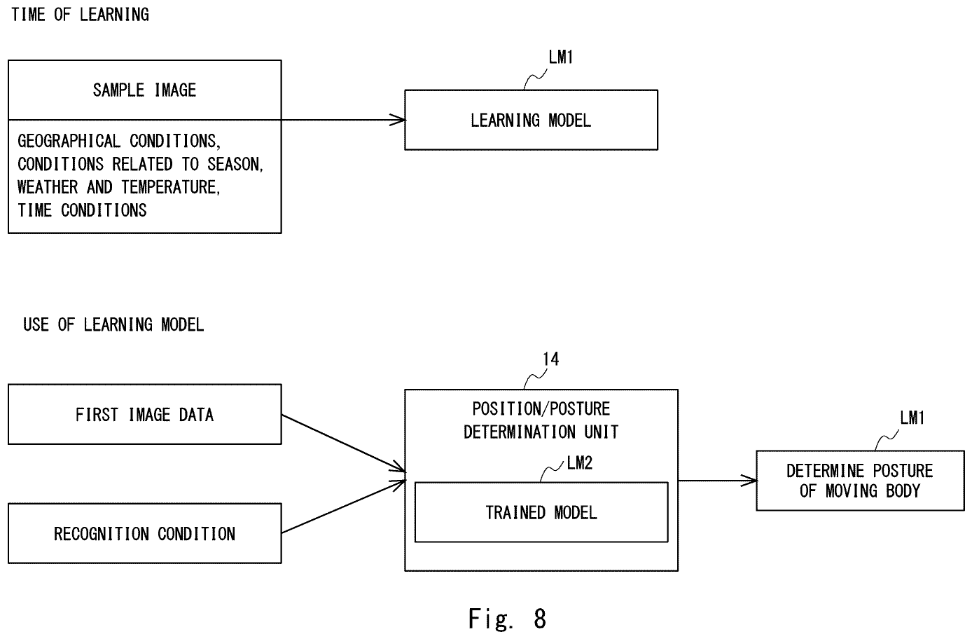

Here, the position/posture determination unit 14 may determine the position/posture of the moving body using a trained model that has learned to determine the position/posture of the moving body using the recognition condition and the first image data including the photographing target as inputs. A more specific description will be given with reference to FIG. 8. FIG. 8 is a diagram illustrating a learning example of a position/posture determination unit in the recording system according to the present disclosure.

As illustrated in FIG. 8, the learning model LM1 is a model generated by learning a sample image in association with geographical conditions, seasonal conditions, weather conditions such as weather, temperature, and wind speed, and date and time conditions. The learning model LM1 is generated, for example, by learning a sample image of a power transmission tower including an inspection point that is a photographing target in association with geographical conditions such as latitude and longitude and weather conditions such as rain. The learning model LM1 is generated, for example, by learning with a neural network or the like. The trained model LM2 is a model in which learning of the learning model LM1 has been completed or a model that is being trained.

As a result, as illustrated in FIG. 8, the position/posture determination unit 14 can determine the position/posture of the moving body using the trained model LM2 by using the recognition condition and the first image data as inputs. For example, in the example illustrated in FIG. 6, there is a recognition condition that the first image data is a power transmission tower photographed at a position of 45 degrees north latitude and 140 degrees east longitude and it is a time of winter dusk at a position of 45 degrees north latitude and 140 degrees east longitude. Therefore, the position/posture determination unit 14 determines to approach the inspection point CP1 from the west side while maintaining an altitude of 20 m using these as inputs by using the trained model LM2. In this manner, the position/posture determination unit 14 can automatically determine the position/posture of the moving body using the trained model LM2.

In addition, if the photographing of the second image data fails, the learning model LM1 may perform relearning by a neural network or the like. That is, the learning model LM1 may be generated by learning the sample image in which the geographical condition, the season condition, the weather condition such as the weather, the temperature, and the wind speed, and the date and time condition are associated in a case where the photographing has failed, and not only in a case where the photographing has succeeded. As a result, the position/posture determination unit 14 can determine the position/posture of the moving body using the trained model LM2 and suppress failure of photographing the second image data.

### <Specification of Photographing Target Using Learning Model>

Here, it has been described that the position/posture determination unit 14 determines the position/posture of the moving body using the trained model. Similarly, the target specifying unit 13 may specify the photographing target from the first image data using the trained model. More specifically, the learning model is generated by learning the sample image in association with the photographing target. For example, in the case of a high-rise building, the inspection point serving as the photographing target is a lightning rod on the rooftop or window, and thus the learning model is generated by learning the sample image of the high-rise building in association with the lightning rod or window. As a result, the target specifying unit 13 can specify the photographing target with the first image data as an input by using the trained model.

In addition, if the photographing of the second image data fails, the learning model may perform relearning by a neural network or the like. That is, the learning model may be generated by learning not only the sample image associated with the photographing target if the photographing of the second image data has succeeded but also the sample image associated with the photographing target if the photographing of the second image data has failed. As a result, the target specifying unit 13 can specify the photographing target using the trained model and suppress failure of photographing the second image data.

### <Creation of Movement Plan Path Using Learning Model>

Furthermore, the target specifying unit 13 may create the movement plan path of the photographing target by using the learning model. In this case, the learning model is generated by learning a sample image in which at least one of the recognition condition and the flight time is associated with the first image data. The target specifying unit 13 can create the movement plan path of the photographing target with the first image data and at least one of the recognition condition and the flight time as inputs by using the trained model.

The learning model is not limited to learning the sample image in which at least one of the recognition condition and the flight time is associated with the first image data if the photographing of the second image data has succeeded. The learning model may learn a sample image in which at least one of the recognition condition and the flight time is associated with the first image data if the photographing of the second image data has failed. With such a configuration, even if the moving body moves according to the movement plan path created by the target specifying unit 13 and the photographing of the second image data fails, the failure result can be reflected in creating the next movement plan path. Therefore, it is possible to suppress failure of photographing the second image data.

In this manner, the target specifying unit 13 can specify the photographing target using the trained model, and further, can create the movement plan path of the photographing target using the trained model.

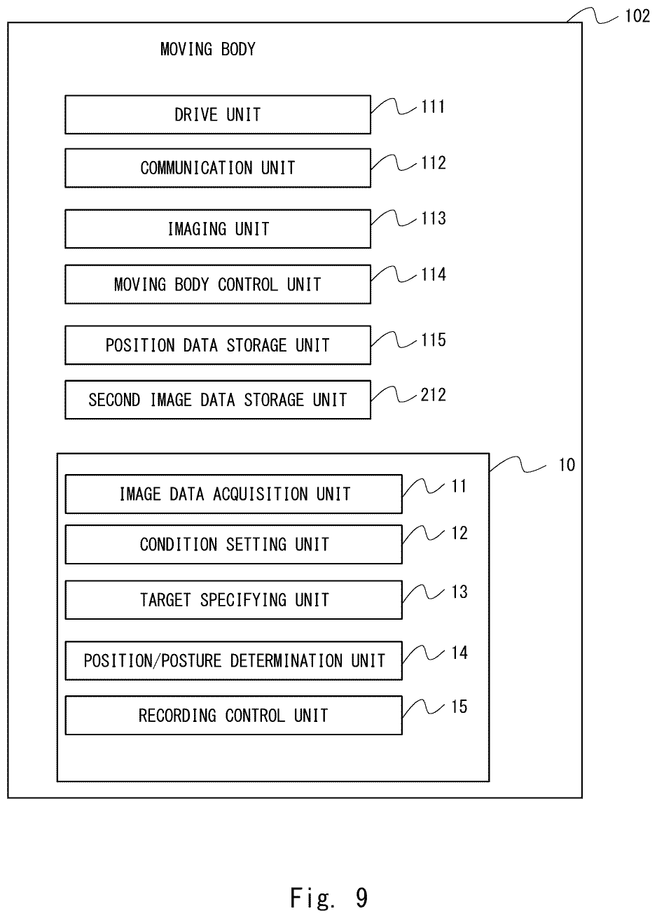

Here, in the usage example of the recording system illustrated in FIG. 3, the moving body 101 and the management device 201 are connected in such a way as to be able to perform wireless communication. The usage example of the recording system is not limited thereto, and may be the example illustrated in FIG. 9. FIG. 9 is a block diagram illustrating a usage example of the recording system according to the present disclosure. In FIG. 9, the moving body 102 includes a drive unit 111, a communication unit 112, an imaging unit 113, a moving body control unit 114, a position data storage unit 115, a second image data storage unit 212, an image data acquisition unit 11, a condition setting unit 12, a target specifying unit 13, a position/posture determination unit 14, and a recording control unit 15. That is, as compared with the usage example of the recording system illustrated in FIG. 3, the moving body 102 can perform all the processing of each functional block without communicating with the management device.

### Third Example Embodiment

### <Recording System>

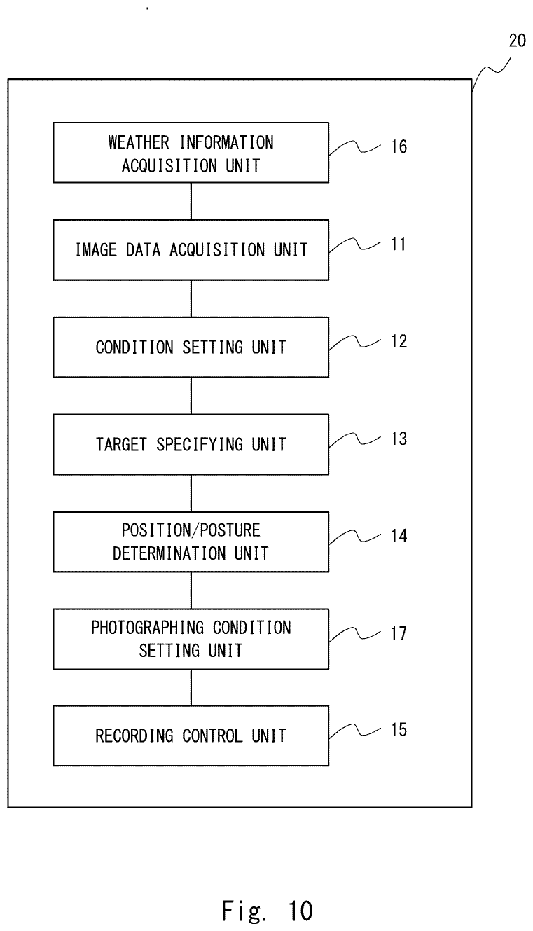

Hereinafter, a recording system according to the present disclosure will be described with reference to the drawings. FIG. 10 is a block diagram of a recording system according to the present disclosure. As illustrated in FIG. 10, the recording system 20 includes a weather information acquisition unit 16, a photographing condition setting unit 17, an image data acquisition unit 11, a condition setting unit 12, a target specifying unit 13, a position/posture determination unit 14, and a recording control unit 15. Since the image data acquisition unit 11, the target specifying unit 13, the position/posture determination unit 14, and the recording control unit 15 are similar to those in FIGS. 1 and 3, the description thereof will be omitted. Here, the weather information acquisition unit 16, the condition setting unit 12, and the photographing condition setting unit 17 will be described.

### <Setting of Recognition Condition Based on Weather Information>

The weather information acquisition unit 16 acquires weather information in the target space. The weather information includes information relating to weather, temperature, and wind speed. The weather information includes past weather data and weather forecast data. For example, the weather information acquisition unit 16 acquires weather data of a place corresponding to the target space from weather data of the Meteorological Agency. The condition setting unit 12 further sets a recognition condition based on weather information at the date and time at which the first image data was photographed.

The weather information acquisition unit 16, the condition setting unit 12, and the position/posture determination unit 14 will be described more specifically. Here, a case where the first image data is obtained by photographing a power transmission tower located at 35 degrees north latitude and 140 degrees east longitude at 11:00 AM on February 20 will be described by way of an example. In addition, it is assumed that the weather forecast at a position of 35 degrees north latitude and 140 degrees east longitude on February 20 is rain in the morning and sunny in the afternoon.

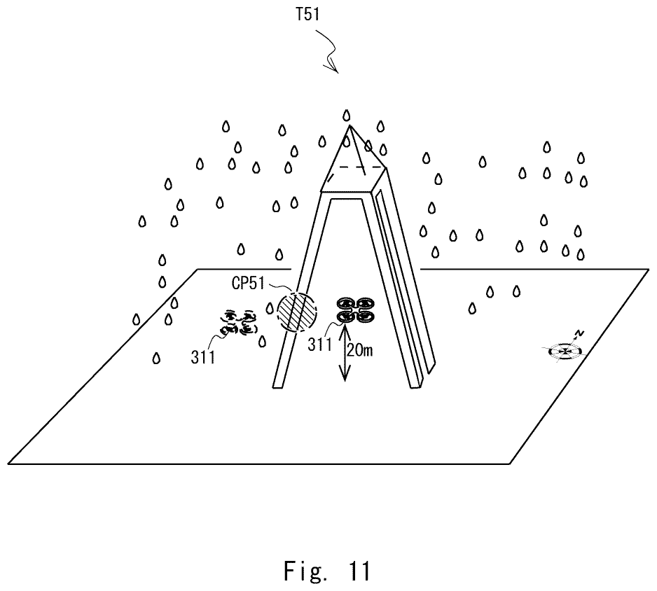

In this case, first, the weather information acquisition unit 16 acquires weather data at a position of 35 degrees north latitude and 140 degrees east longitude indicating that it is rainy in the morning and sunny in the afternoon. Next, the condition setting unit 12 determines that the first image data was photographed at a position of 35 degrees north latitude and 140 degrees east longitude at 11:00 AM on February 20, and it is a rain forecast at 11:00 AM at a position of 35 degrees north latitude and 140 degrees east longitude from the acquired weather data. Then, the condition setting unit 12 sets a recognition condition that it is a time zone before noon at a position of 35 degrees north latitude and 140 degrees east longitude and it is raining. Based on this recognition condition, the position/posture determination unit 14 determines the position/posture of the moving body for photographing the second image data. An example of the position/posture of the moving body determined by the position/posture determination unit 14 will be described with reference to FIG. 11.

FIG. 11 is a schematic diagram illustrating a usage example of the recording system according to the present disclosure. FIG. 11 illustrates a state in which the inspection point CP51 of a radio tower T51 located at 35 degrees north latitude and 140 degrees east longitude is photographed using the moving body 311 at 11:00 AM. Furthermore, in FIG. 11, it is assumed that the left direction of the drawing is the west side and the depth direction of the drawing is the north side.

As illustrated in FIG. 11, since it is raining around the radio tower T51, if the inspection point CP51 is to be photographed from the west side, the second image data will include rain. On the other hand, if the inspection point CP51 is photographed from the east side in a state where the inspection point CP51 is located below the radio tower T51, rain is hindered by the radio tower T51, and the second image data will not include rain and becomes a clear image. Therefore, for example, the position/posture determination unit 14 determines to fly while maintaining an altitude of 20 m on the east side with respect to the inspection point CP1 in such a way that the moving body 311 can photograph from the east side with respect to the inspection point CP51.

As described above, by including the weather information acquisition unit 16, the recording system 20 can set the recognition condition in consideration of the weather information in the target space, and can determine the position/posture of the moving body according to the recognition condition. Therefore, more accurate second image data can be acquired, and the user can more reliably confirm the photographing target.

### <Setting of Photographing Condition>

The photographing condition setting unit 17 sets the photographing condition for photographing the second image data based on the recognition condition. The photographing condition is a setting of the imaging unit of the moving body, and includes, for example, zoom, brightness, contrast, color setting, presence/absence of flash, photographing time, shutter speed, and the like. More specifically, in a case of a recognition condition that it is a time zone before noon at a position of 35 degrees north latitude and 140 degrees east longitude and it is raining, the photographing condition setting unit 17 adjusts brightness and contrast in order to photograph the second image data.

As described above, by providing the photographing condition setting unit 17, the second image data can be photographed in accordance with the recognition condition, so that the more accurate second image data can be acquired, and the user can confirm the photographing target.

### Fourth Example Embodiment

### <Recording System>

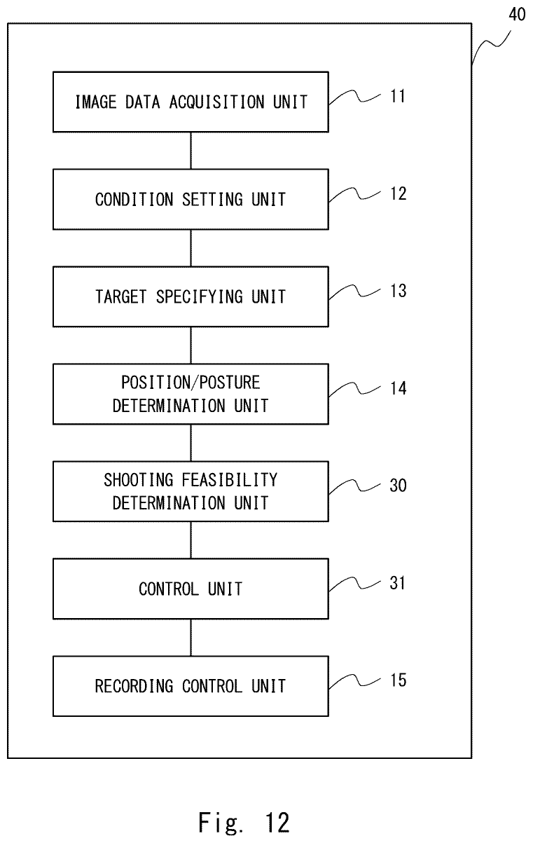

Hereinafter, a recording system according to the present disclosure will be described with reference to the drawings. FIG. 12 is a block diagram of a recording system according to the present disclosure. As illustrated in FIG. 12, the recording system 40 includes a shooting feasibility determination unit 30, a control unit 31, an image data acquisition unit 11, a condition setting unit 12, a target specifying unit 13, a position/posture determination unit 14, and a recording control unit 15. Since the image data acquisition unit 11, the condition setting unit 12, the target specifying unit 13, the position/posture determination unit 14, and the recording control unit 15 are similar to those in FIGS. 1, 3 and 10, the description thereof will be omitted. Here, the shooting feasibility determination unit 30 and the control unit 31 will be described.

The shooting feasibility determination unit 30 determines whether photographing of the photographing target has succeeded based on the second image data. For example, in a case where a photographing target is included in the second image data and the user can confirm the photographing target, the shooting feasibility determination unit 30 determines that the photographing of the photographing target has succeeded. On the other hand, for example, in a case where the photographing target is not included in the second image data or in a case where the photographing target is included in the second image data but is too dark and thus is not clear and cannot be confirmed, it is determined that the photographing of the photographing target has not succeeded.

The control unit 31 controls the moving body according to the determination result of the shooting feasibility determination unit 30. More specifically, in a case where the shooting feasibility determination unit 30 determines that the photographing of the photographing target has succeeded, the control unit 31 performs control such that the moving body leaves the target space.

On the other hand, in a case where the shooting feasibility determination unit 30 does not determine that the photographing of the photographing target has succeeded, the recognition condition is reset, and the control unit 31 performs control in such a way that the moving body executes the photographing of the photographing target again.

With such a configuration, even in a case where the weather is sunny at the time the recognition condition is set, but the weather changes to rain at the timing at the time the second image is photographed, accurate second image data can be acquired by resetting the recognition condition and performing photographing again. Therefore, the user can more reliably confirm the photographing target.

In addition, in a case where the shooting feasibility determination unit 30 does not determine that the photographing of the photographing target has succeeded, the control unit 31 may perform control such that the moving body leaves the target space after a predetermined time has elapsed from the start of the photographing of the photographing target. With such a configuration, for example, in a case where the second image data in which the photographing target can be confirmed cannot be acquired even if photographing is performed many times due to the recognition condition that the weather is bad, the second image data of another photographing target can be acquired first.

In addition, in a case where the shooting feasibility determination unit 30 does not determine that the photographing of the photographing target has succeeded, the control unit 31 may perform control such that the moving body leaves the target space after photographing the photographing target a predetermined number of times. With such a configuration, for example, even in a case where the weather is unstable, accurate second image data can be acquired by performing photographing a plurality of times.

Here, the recording system 40 may further include an approach detection unit for detecting that another moving body is approaching the moving body that has photographed the photographing target. For example, the approach detection unit acquires position data of the own position estimation unit 116 of each moving body illustrated in FIG. 3 and detects that another moving body is approaching. In addition, the approach detection unit may be configured to detect that another moving body is approaching by a proximity sensor provided in the moving body, and acquire information that another moving body is approaching.

In a case where the shooting feasibility determination unit 30 does not determine that the photographing of the photographing target has succeeded, the control unit 31 may execute the following processing. If the approach detection unit detects that another moving body is approaching, the control unit 31 performs control in such a way that the moving body that has photographed the photographing target leaves the target space in such a way that the another moving body and the moving body that has photographed the photographing target do not interfere with each other.

In addition, in the control unit 31, the timing for causing the moving body that has photographed the photographing target to leave the target space may be at any timing as long as the another moving body and the moving body that has photographed the photographing target do not interfere with each other. For example, in a case where another moving body enters the target space, the control unit 31 may cause the moving body that has photographed the photographing target to leave the target space. As another example, the control unit 31 may cause the moving body that has photographed the photographing target to leave the target space before another moving body moves to a position overlapping the 5 moving body that has photographed the photographing target.

With such a configuration, even if another moving body flies to photograph a photographing target, the moving bodies can acquire the second image data without interfering with each other, and the user can confirm the photographing target.

### <Recording Method>

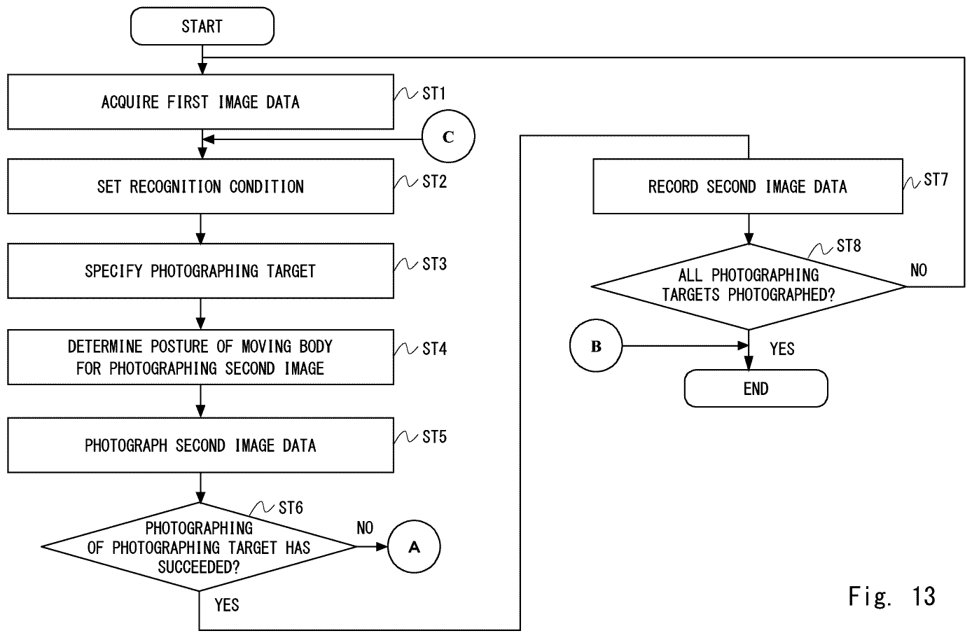

Next, a recording method according to the present disclosure will be described. FIGS. 13 to 15 are flowcharts illustrating a recording method according to the present disclosure. Steps ST1 to ST5 are similar to the recording method illustrated in FIG. 2, and thus description thereof will be omitted.

As illustrated in FIG. 13, following step ST5, the shooting feasibility determination unit 30 determines whether the photographing of the photographing target has succeeded (step ST6). If the shooting feasibility determination unit 30 determines that the photographing of the photographing target has succeeded (step ST6 YES), for example, the recording control unit 15 records the second image data in a memory such as a RAM or a ROM, as illustrated in FIG. 13 (step ST7).

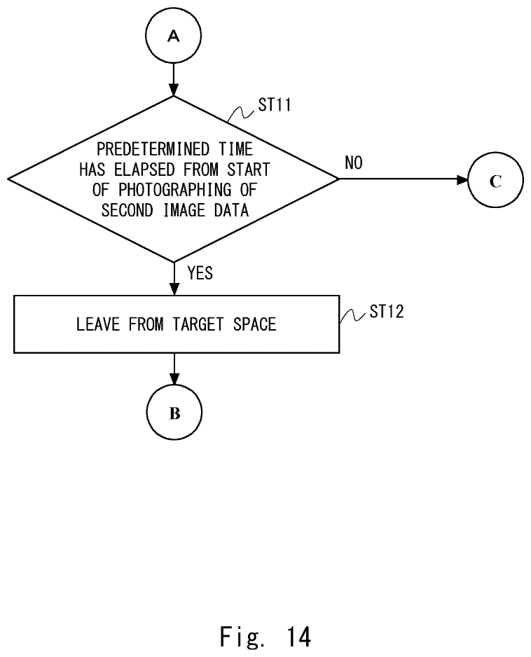

On the other hand, if the shooting feasibility determination unit 30 does not determine that the photographing of the photographing target has succeeded (step ST6 NO), as illustrated in FIG. 14, the control unit 31 determines whether a predetermined time has elapsed from the start of photographing of the second image data (step ST11). If the predetermined time has elapsed from the start of photographing of the second image data (step ST11 YES), the control unit 31 performs control in such a way that the moving body that has photographed the photographing target leaves the target space (step ST12). If the predetermined time has not elapsed from the start of photographing of the second image data (step ST11 NO), the control unit 31 returns to step ST2 and resets the recognition condition.

Here, in a case where the approach detection unit detects that another moving body is approaching the moving body that has photographed the photographing target, the following may be performed.

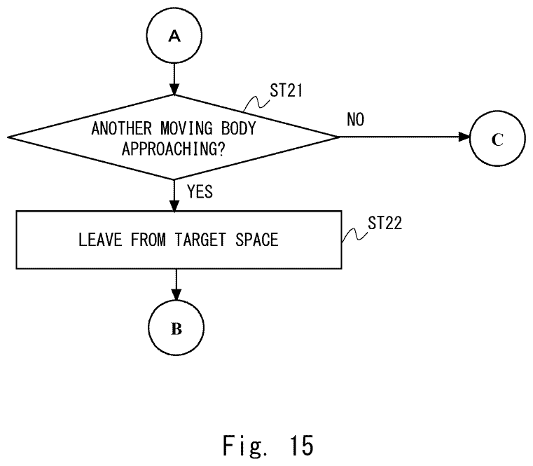

If the shooting feasibility determination unit 30 does not determine that the photographing of the photographing target has succeeded (step ST6 NO), as illustrated in FIG. 15, the control unit 31 the approach detection unit determines whether another moving body is approaching the moving body that has photographed the photographing target (step ST21). If the approach detection unit detects that another moving body is approaching the moving body that has photographed the photographing target (step ST21 YES), the control unit 31 performs control in such a way that the moving body that has photographed the photographing target leaves the target space (step ST22). If the approach detection unit has not detected that another moving body is approaching the moving body that has photographed the photographing target (step ST21 NO), the control unit 31 returns to step ST2 and resets the recognition condition.

Here, whether the predetermined time has elapsed from the start of photographing of the second image data and whether another moving body is approaching the moving body that has photographed the photographing target are illustrated using different flowcharts. However, this is not the sole case, and both whether a predetermined time has elapsed from the start of photographing of the second image data and whether another moving body is approaching the moving body that has photographed the photographing target may be determined. For example, If the approach detection unit has not detected that another moving body is approaching the moving body that has photographed the photographing target (step ST21 NO), the control unit 31 may perform the determination in step ST11.

Returning to FIG. 13, the description will be continued. Subsequent to step ST7, the shooting feasibility determination unit 30 determines whether all the photographing targets have been photographed (step ST8). If the shooting feasibility determination unit 30 determines that all the photographing targets have been photographed (step ST8 YES), the present recording method is ended. On the other hand, if the shooting feasibility determination unit 30 determines that not all the photographing targets are photographed (step ST8 NO), the processing returns to step ST1, and the image data acquisition unit 11 acquires the first image data in order to execute photographing of the next photographing target.

As described above, in the recording system 40 according to the present disclosure, the shooting feasibility determination unit 30 determines whether photographing of the photographing target has succeeded based on the second image data, and the control unit 31 controls the moving body based on the determination result of the shooting feasibility determination unit 30. With such a configuration, even if the photographing of the photographing target has not succeeded, the recognition condition is reset, and the second image data can be accurately acquired by photographing again. Therefore, the user can more reliably confirm the photographing target.

Furthermore, even if the photographing of the photographing target has not succeeded, the recording system 40 according to the present disclosure can perform control in such a way that the moving body that has photographed the photographing target leaves the target space in a case where a predetermined time has elapsed from the start of photographing of the second image or in a case where another moving body is approaching. With such a configuration, the recording system 40 according to the present disclosure can prevent collision between moving bodies even if another moving body flies to photograph a photographing target.

### Configuration Example

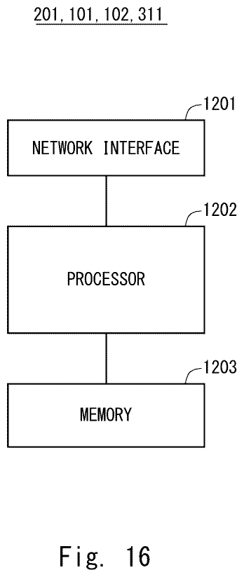

FIG. 16 is a block diagram illustrating a configuration example of the management device 201 and the moving bodies 101, 102, and 311 (hereinafter referred to as a management device 201 or the like) according to the present disclosure. Referring to FIG. 16, the management device 201 or the like includes a network interface 1201, a processor 1202, and a memory 1203. The network interface 1201 may be used to communicate with network nodes. The network interface 1201 may include, for example, a Network Interface Card (NIC) conforming to IEEE 802.3 series. The IEEE represents the Institute of Electrical and Electronics Engineers.

The processor 1202 reads and executes software (computer program) from the memory 1203 to perform processing of the management device 201 or the like described using the flowcharts in the above-described example embodiments. The processor 1202 may be, for example, a microprocessor, a micro processing unit (MPU), or a central processing unit (CPU). The processor 1202 may include a plurality of processors.

The memory 1203 is constituted by a combination of a volatile memory and a nonvolatile memory. The memory 1203 may include a storage disposed away from the processor 1202. In this case, the processor 1202 may access the memory 1203 via an Input/Output (I/O) interface (not illustrated).

In the example in FIG. 16, the memory 1203 is used to save a software module group. The processor 1202 can perform the processing of the management device 201 or the like described in the above-described example embodiments by reading and executing these software module groups from the memory 1203.

As described with reference to FIG. 16, each of the processors included in the management device 201 or the like executes one or a plurality of programs including a command group for causing a computer to perform the algorithm described with reference to the drawings.

In addition, a part or all of the processing in the recording system according to the present disclosure described above can be achieved as a computer program. Such a program can be stored and supplied to the computer using various types of non-transitory computer-readable media. The non-transitory computer-readable media include various types of tangible recording media. Examples of the non-transitory computer-readable media include a magnetic recording medium (e.g., a flexible disk, a magnetic tape, or a hard disk drive), a magneto-optical recording medium (e.g., a magneto-optical disc), a CD-Read Only Memory (ROM), a CD-R, a CD-R/W, and a semiconductor memory (e.g., a mask ROM, a Programmable ROM (PROM), an Erasable PROM (EPROM), a flash ROM, or a Random Access Memory (RAM)). The program may be supplied to the computer using various types of transitory computer-readable media. Examples of the transitory computer-readable media include electric signals, optical signals, and electromagnetic waves. The transitory computer-readable media can provide the program to the computer via a wired communication line such as an electric wire and optical fibers or a wireless communication line.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each example embodiment can be appropriately combined with other example embodiments.

Each of the drawings is merely an example for describing one or more example embodiments. Each of the drawings is not associated with only one specific example embodiment, but may be associated with one or more other example embodiments. As those of ordinary skill in the art will appreciate, various features or steps described with reference to any one of the drawings may be combined with features or steps illustrated in one or more other figures, for example, to create an example embodiment that is not explicitly illustrated or described. All of the features or steps illustrated in any one of the figures to explain illustrative example embodiments are not necessarily mandatory, and some features or steps may be omitted. The order of the steps described in any of the figures may be changed as appropriate.

Some or all of the above example embodiments may be described as the following Supplementary Notes, but are not limited to the following.

### (Supplementary Note 1)

A recording system including:
an image data acquisition unit for acquiring first image data photographed by a camera provided in a moving body that has moved to a target space based on position data registered in advance;
a condition setting unit for setting a recognition condition for recognizing a photographing target based on at least one of a position of the target space and a date and time at which the first image data is photographed;
a target specifying unit for specifying the photographing target from the first image data;
a position/posture determination unit for determining a position/posture of the moving body with respect to the photographing target based on the recognition condition to photograph second image data including the photographing target; and
a recording control unit for recording the second image data.

### (Supplementary Note 2)

The recording system according to Supplementary Note 1, further including: a shooting feasibility determination unit for determining whether photographing of the photographing target has succeeded based on the second image data.

### (Supplementary Note 3)

The recording system according to Supplementary Note 2, further including a control unit for controlling the moving body according to a determination result of the shooting feasibility determination unit, in which
in a case where the shooting feasibility determination unit determines that photographing of the photographing target has succeeded, the control unit performs control in such a way that the moving body leaves the target space, and
in a case where the shooting feasibility determination unit does not determine that photographing of the photographing target has succeeded, the recognition condition is reset, and the control unit performs control in such a way that the moving body executes photographing of the photographing target again.

### (Supplementary Note 4)

The recording system according to Supplementary Note 3, in which in a case where the shooting feasibility determination unit does not determine that the photographing of the photographing target has succeeded, the control unit performs control in such a way that the moving body leaves the target space after a predetermined time has elapsed from start of the photographing of the photographing target.

### (Supplementary Note 5)

The recording system according to Supplementary Note 3 or 4, further including an approach detection unit for detecting that another moving body is approaching the moving body that has photographed the photographing target,
in which in a case where the shooting feasibility determination unit does not determine that photographing of the photographing target has succeeded, the control unit performs controls in such a way as to cause the moving body that has photographed the photographing target to leave the target space in such a way that another moving body and the moving body that has photographed the photographing target do not interfere with each other after the approach detection unit detects that the another moving body is approaching,

### (Supplementary Note 6)

The recording system according to Supplementary Note 1 or 2, in which
the first image data includes a plurality of the photographing targets, and
the target specifying unit creates a movement plan path of the photographing target from the first image data based on the recognition condition.

### (Supplementary Note 7)

The recording system according to Supplementary Note 1 or 2, in which the condition setting unit sets the recognition condition based on a position of the target space and a date and time at which the first image data is photographed.

### (Supplementary Note 8)

The recording system according to Supplementary Note 1 or 2, further including a weather information acquisition unit for acquiring weather information,
in which the condition setting unit further sets the recognition condition based on weather information at a date and time at which the first image data is photographed.

### (Supplementary Note 9)

The recording system according to Supplementary Note 1 or 2, wherein the position/posture determination unit determines a position/posture of the moving body using a trained model that has learned to determine the position/posture of the moving body using the recognition condition and the first image data including the photographing target as inputs.

### (Supplementary Note 10)

The recording system according to Supplementary Note 1 or 2, further including a photographing condition setting unit for setting a photographing condition for photographing the second image data based on the recognition condition.

### (Supplementary Note 11)

The recording system according to Supplementary Note 1 or 2, in which the moving body is an autonomous flying object capable of autonomous flight.

### (Supplementary Note 12)

A recording method executed by a computer and including:
acquiring first image data photographed by a camera provided in a moving body that has moved to a target space based on position data registered in advance;
setting a recognition condition for recognizing a photographing target based on at least one of a position of the target space and a date and time at which the first image data is photographed;
specifying the photographing target from the first image data, and determining a position/posture of the moving body with respect to the photographing target for photographing a second image including the photographing target according to the recognition condition; and
recording the second image data in which the photographing target is photographed.

### (Supplementary Note 13)

The recording method according to Supplementary Note 12, further including determining whether photographing of the photographing target has succeeded based on the second image data.

### (Supplementary Note 14)

The recording method according to Supplementary Note 13, further including:
performing control in such a way that the moving body leaves the target space in a case where it is determined that the photographing of the photographing target has succeeded; and
resetting the recognition condition and performing a control in such a way that the moving body executes the photographing of the photographing target again in a case where it is not determined that the photographing of the photographing target has succeeded.

### (Supplementary Note 15)

The recording method according to Supplementary Note 14, further including performing control in such a way that the moving body leaves the target space after elapse of a predetermined time from start of photographing of the photographing target in a case where it is not determined that the photographing of the photographing target has succeeded.

### (Supplementary Note 16)

The recording method according to Supplementary Note 14 or 15, further including:
detecting that another moving body is approaching the moving body that has photographed the photographing target; and
in a case where it is not determined that photographing of the photographing target has succeeded, performing control in such a way as to cause the moving body that has photographed the photographing target to leave the target space in such a way that another moving body and the moving body that has photographed the photographing target do not interfere with each other after the approach of the another moving body is detected.

### (Supplementary Note 17)

The recording method according to Supplementary Note 12 or 13, in which
the first image data includes a plurality of the photographing targets, and
a movement plan path of the photographing target is created from the first image data based on the recognition condition.

### (Supplementary Note 18)

The recording method according to Supplementary Note 12 or 13, further including setting the recognition condition based on a position of the target space and a date and time at which the first image data is photographed.

### (Supplementary Note 19)

The recording method according to Supplementary Note 12 or 13, further including:
acquiring weather information; and
setting the recognition condition based on weather information at a date and time at which the first image data is photographed.

### (Supplementary Note 20)

The recording method according to Supplementary Note 12 or 13, further including determining a position/posture of the moving body using a trained model that has learned to determine the position/posture of the moving body using the recognition condition and the first image data including the photographing target as inputs.

### (Supplementary Note 21)

The recording method according to Supplementary Note 12 or 13, further including setting a photographing condition for photographing the second image data based on the recognition condition.

### (Supplementary Note 22)

The recording method according to Supplementary Note 12 or 13, in which the moving body is an autonomous flying object capable of autonomous flight.

### (Supplementary Note 23)

A recording program for causing a computer to execute processing of:
acquiring first image data photographed by a camera provided in a moving body that has moved to a target space based on position data registered in advance;
setting a recognition condition for recognizing a photographing target based on at least one of a position of the target space and a date and time at which the first image data is photographed;
specifying the photographing target from the first image data, and determining a position/posture of the moving body with respect to the photographing target for photographing a second image including the photographing target according to the recognition condition; and
recording the second image data in which the photographing target is photographed.

### (Supplementary Note 24)

The recording program according to Supplementary Note 23, further causing the computer to execute processing of determining whether photographing of the photographing target has succeeded based on the second image data.

### (Supplementary Note 25)

The recording program according to Supplementary Note 24, further causing the computer to execute processing of:
performing control in such a way that the moving body leaves the target space in a case where it is determined that the photographing of the photographing target has succeeded; and
resetting the recognition condition and performing a control in such a way that the moving body executes the photographing of the photographing target again in a case where it is not determined that the photographing of the photographing target has succeeded.

### (Supplementary Note 26)

The recording program according to Supplementary Note 24, further causing the computer to execute processing of performing control in such a way that the moving body leaves the target space after elapse of a predetermined time from start of photographing of the photographing target in a case where it is not determined that the photographing of the photographing target has succeeded.

### (Supplementary Note 27)

The recording program according to Supplementary Note 25 or 26, further causing the computer to execute processing of:
detecting that another moving body is approaching the moving body that has photographed the photographing target; and
in a case where it is not determined that photographing of the photographing target has succeeded, performing control in such a way as to cause the moving body that has photographed the photographing target to leave the target space in such a way that another moving body and the moving body that has photographed the photographing target do not interfere with each other after the approach of the another moving body is detected.

### (Supplementary Note 28)

The recording program according to Supplementary Note 23 or 24, in which
the first image data includes a plurality of the photographing targets, and
a movement plan path of the photographing target is created from the first image data based on the recognition condition.

### (Supplementary Note 29)

The recording program according to Supplementary Note 23 or 24, further causing the computer to execute processing of setting the recognition condition based on a position of the target space and a date and time at which the first image data is photographed.

### (Supplementary Note 30)

The recording program according to Supplementary Note 23 or 24, further causing the computer to execute processing of:
acquiring weather information; and
setting the recognition condition based on weather information at a date and time at which the first image data is photographed.

### (Supplementary Note 31)

The recording program according to Supplementary Note 23 or 24, further causing the computer to execute processing of determining a position/posture of the moving body using a trained model that has learned to determine the position/posture of the moving body using the recognition condition and the first image data including the photographing target as inputs.

### (Supplementary Note 32)

The recording program according to Supplementary Note 23 or 24, further causing the computer to execute processing of setting a photographing condition for photographing the second image data based on the recognition condition.

### (Supplementary Note 33)

The recording program according to Supplementary Note 23 or 24, in which the moving body is an autonomous flying object capable of autonomous flight.

This application is based upon and claims the benefit of priority from Japanese patent application No. 2023-049090, filed on Mar. 24, 2023, the disclosure of which is incorporated herein in its entirety by reference.

### REFERENCE SIGNS LIST

10, 20, 40 recording system
11 image data acquisition unit
12 condition setting unit
13 target specifying unit
14 position/posture determination unit
15 recording control unit
16 weather information acquisition unit
17 photographing condition setting unit
30 shooting feasibility determination unit
31 control unit
101, 102, 311 moving body
111 drive unit
112 communication unit
113 imaging unit
114 moving body control unit
115 position data storage unit
116 own position estimation unit
201 management device
211 communication unit
212 second image data storage unit
300 first image data
400 second image data
1201 network interface
1202 processor
1203 memory
CP1, CP11, CP12, CP13, CP51 inspection point
L1 movement route
LM1 learning model
LM2 trained model
T1, T11 power transmission tower
T51 radio tower
TS1 target space

What is claimed is:

1. A recording system comprising:
at least one memory storing instructions; and
at least one processor configured to execute the instructions to:
acquire first image data photographed by a camera provided in a moving body that has moved to a target space based on position data registered in advance;
set a recognition condition for recognizing a photographing target based on at least one of a position of the target space and a date and time at which the first image data is photographed;
specify the photographing target from the first image data;
determine a position/posture of the moving body with respect to the photographing target based on the recognition condition to photograph second image data including the photographing target; and
record the second image data.

2. The recording system according to claim 1, wherein the at least one processor is further configured to execute the instructions to:
determine whether photographing of the photographing target has succeeded based on the second image data.

3. The recording system according to claim 2, wherein the at least one processor is further configured to execute the instructions to control the moving body according to a determination result of the shooting feasibility determination means, wherein
in a case wherein the at least one processor is further configured to execute the instructions to determine that photographing of the photographing target has succeeded, wherein the at least one processor is further configured to execute the instructions to control in such a way that the moving body leaves the target space, and
in a case wherein the at least one processor is further configured to execute the instructions to determine that photographing of the photographing target has not succeeded, the recognition condition is reset, and wherein the at least one processor is further configured to execute the instructions to control in such a way that the moving body executes photographing of the photographing target again.

4. The recording system according to claim 3, in which in a case wherein the at least one processor is further configured to execute the instructions to determine that the photographing of the photographing target has not succeeded, wherein the at least one processor is further configured to execute the instructions to control in such a way that the moving body leaves the target space after a predetermined time has elapsed from start of the photographing of the photographing target.

5. The recording system according to claim 3, wherein the at least one processor is further configured to execute the instructions to detect that another moving body is approaching the moving body that has photographed the photographing target,
wherein in a case where wherein the at least one processor is further configured to execute the instructions to determine that photographing of the photographing target has not succeeded, wherein the at least one processor is further configured to execute the instructions to control to cause the moving body that has photographed the photographing target to leave the target space in such a way that another moving body and the moving body that has photographed the photographing target do not interfere with each other after the approach detection means detects that the another moving body is approaching.

6. The recording system according to claim 1, wherein
the first image data includes a plurality of the photographing targets, and
wherein the at least one processor is further configured to execute the instructions to create a movement plan path of the photographing target from the first image data based on the recognition condition.

7. The recording system according to claim 1, wherein the at least one processor is further configured to execute the instructions to acquire weather information,
wherein the at least one processor is further configured to execute the instructions to set the recognition condition based on weather information at a date and time at which the first image data is photographed.

8. The recording system according to claim 1, wherein the at least one processor is further configured to execute the instructions to determine a position/posture of the moving body using a trained model that has learned to determine the position/posture of the moving body using the recognition condition and the first image data including the photographing target as inputs.

9. A recording method executed by a computer and comprising:
acquiring first image data photographed by a camera provided in a moving body that has moved to a target space based on position data registered in advance;
setting a recognition condition for recognizing a photographing target based on at least one of a position of the target space and a date and time at which the first image data is photographed;
specifying the photographing target from the first image data, and determining a position/posture of the moving body with respect to the photographing target for photographing a second image including the photographing target according to the recognition condition; and
recording the second image data in which the photographing target is photographed.

10. The recording method according to claim 9, further comprising determining whether photographing of the photographing target has succeeded based on the second image data.

11. The recording method according to claim 10, further comprising:
performing control in such a way that the moving body leaves the target space in a case where it is determined that the photographing of the photographing target has succeeded; and
resetting the recognition condition and performing control in such a way that the moving body executes the photographing of the photographing target again in a case where it is not determined that the photographing of the photographing target has succeeded.

12. The recording method according to claim 11, further comprising performing control in such a way that the moving body leaves the target space after elapse of a predetermined time from start of photographing of the photographing target in a case where it is not determined that the photographing of the photographing target has succeeded.

13. The recording method according to claim 11, further comprising:
detecting that another moving body is approaching the moving body that has photographed the photographing target; and
in a case where it is not determined that photographing of the photographing target has succeeded, performing control to cause the moving body that has photographed the photographing target to leave the target space in such a way that another moving body and the moving body that has photographed the photographing target do not interfere with each other after the approach of the another moving body is detected.

14. The recording method according to claim 9 or 10, wherein
the first image data includes a plurality of the photographing targets, and
a movement plan path of the photographing target is created from the first image data based on the recognition condition.

15. A non-transitory computer readable medium storing a recording program for causing a computer to execute processing of:
acquiring first image data photographed by a camera provided in a moving body that has moved to a target space based on position data registered in advance;
setting a recognition condition for recognizing a photographing target based on at least one of a position of the target space and a date and time at which the first image data is photographed;
specifying the photographing target from the first image data, and determining a position/posture of the moving body with respect to the photographing target for photographing a second image including the photographing target according to the recognition condition; and
recording the second image data in which the photographing target is photographed.

16. The non-transitory computer readable medium storing a recording program according to claim 15, further causing the computer to execute processing of determining whether photographing of the photographing target has succeeded based on the second image data.

17. The non-transitory computer readable medium storing a recording program according to claim 16, further causing the computer to execute processing of:
performing control in such a way that the moving body leaves the target space in a case where it is determined that the photographing of the photographing target has succeeded; and
resetting the recognition condition and performing control in such a way that the moving body executes the photographing of the photographing target again in a case where it is not determined that the photographing of the photographing target has succeeded.

18. The non-transitory computer readable medium storing a recording program according to claim 17, further causing the computer to execute processing of performing control in such a way that the moving body leaves the target space after elapse of a predetermined time from start of photographing of the photographing target in a case where it is not determined that the photographing of the photographing target has succeeded.

19. The non-transitory computer readable medium storing a recording program according to claim 17, further causing the computer to execute processing of:
detecting that another moving body is approaching the moving body that has photographed the photographing target; and
in a case where it is not determined that photographing of the photographing target has succeeded, performing control to cause the moving body that has photographed the photographing target to leave the target space in such a way that another moving body and the moving body that has photographed the photographing target do not interfere with each other after the approach of the another moving body is detected.

20. The non-transitory computer readable medium storing a recording program according to claim 15, wherein
the first image data includes a plurality of the photographing targets, and
a movement plan path of the photographing target is created from the first image data based on the recognition condition.
